(19) United States
(12) Patent Application Publication
(10) Pub. No.: US 2009/0250303 A1
(43) Pub. Date: Oct. 8, 2009

(54) CLUTCH

(75) Inventor: Kazutoshi MATSUZAKI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/417,200

(22) Filed: Apr. 2, 2009

(30) Foreign Application Priority Data
Apr. 8, 2008 (JP) 2008-100686

(51) Int. Cl. F16D 43/02

(52) U.S. Cl. 192/46

(57) ABSTRACT

A clutch includes: an inner gear; a rack which is configured to mesh with the inner gear; a holder which is formed in an annular shape so as to have therein the inner gear and the rack and holds the rack so as to be slidable, the holder being configured to rotate together with the inner gear and the rack upon receiving a rotation torque of the inner gear via the rack; and an outer gear which is formed in an annular shape so as to have therein the holder and is rotatable relative to the inner gear, the rack, and the holder.

### BACKGROUND

1. Technical Field

The present invention relates to a clutch which enables or disables a torque transmission state between an inner gear and an outer gear.

2. Related Art

Japanese Patent Application Laid-Open No. H10-331941 discloses an example of a clutch which transmits a power to a target to be driven only when a motor rotates in one direction. The one-way clutch disclosed in Japanese Patent Application Laid-Open No. H10-331941 includes a planetary gear; an inner member provided with a concave portion which receives the planetary gear; and an outer member provided with an internal tooth gear which meshes with the planetary gear, wherein one surface of the concave portion is provided with a protrusion and the other surface thereof is not provided with a protrusion.

Accordingly, when the inner member rotates in a predetermined direction so that the planetary gear comes into contact with the other surface (which is not provided with the protrusion) of the concave portion, the planetary gear is in a changeable state. That is, the planetary gear meshes with the internal tooth gear of the outer member while rotating in the inside of the concave portion of the inner member. As a result, the torque is not transmitted from the inner member to the outer member.

However, when the inner member rotates in a direction opposite to the predetermined direction so that the planetary gear comes into contact with one surface (which is provided with the protrusion) of the concave portion, the planetary gear is in an unchangeable state. That is, the planetary gear meshes with the internal tooth gear of the outer member in the state where the rotation of the planetary gear inside the concave portion of the inner member is locked by the protrusion. As a result, the torque is transmitted from the inner member to the outer member via the planetary gear.

However, in the one-way clutch disclosed in Japanese Patent Application Laid-Open No. H10-331941, since the planetary gear meshes with the internal tooth gear of the outer member while rotating in the inside of the concave portion of the inner member during the time when the torque is not transmitted from the inner member to the outer member, a rotation load is applied to the motor. Accordingly, even at the time when the torque is not transmitted from the inner member to the outer member, an operation sound occurs in the inside of the clutch due to the gears meshing with each other.

### SUMMARY

An advantage of some aspects of the invention is that it provides a clutch capable of reducing a load applied to a motor even in a torque non-transmission state and of more silently operating the motor.

According to an aspect of the invention, there is provided a clutch including: an inner gear; a rack which is configured to mesh with the inner gear; a holder which is formed in an annular shape so as to have therein the inner gear and the rack and holds the rack so as to be slidable, the holder being configured to rotate together with the inner gear and the rack upon receiving a rotation torque of the inner gear via the rack; and an outer gear which is formed in an annular shape so as to have therein the holder and is rotatable relative to the inner gear, the rack, and the holder, wherein an opening is formed in the holder so as to allow the front end of the rack to protrude to the outside of the holder when the inner gear rotates in a predetermined direction, wherein a contact portion is formed on the inside of the outer gear so as to come into contact with the front end of the rack protruding to the outside of the holder when the inner gear rotates in the predetermined direction, and wherein the rack transmits the rotation torque of the inner gear to the outer gear via the contact portion when the inner gear rotates in the predetermined direction.

With such a configuration, a switching operation between a torque transmission state (the rotation torque of the inner gear is transmitted to the outer gear) and a torque non-transmission state (the rotation torque of the inner gear is not transmitted to the outer gear) is carried out by a sliding operation of the rack slidably provided in the holder. Also, except for the time when the switching operation between the torque transmission state and the torque non-transmission state is carried out, the rack meshes with the inner gear so as to disable the relative movement therebetween regardless of whether it is the torque transmission state or the torque non-transmission state. Accordingly, it is possible to reduce a load applied to a motor and to silently operate the motor in the torque non-transmission state.

In the clutch according to this aspect, a plurality of the racks may be provided, and the plurality of racks may be disposed so as to be point symmetrical to each other with respect to a rotation center of the inner gear.

With such a configuration, since the plurality of racks is disposed so as to be point symmetrical to each other with respect to the rotation center of the inner gear, the torque transmission positions of the outer gear are point symmetrical to each other with respect to the rotation center. Accordingly, it is possible to transmit the torque from the inner gear to the outer gear in a stabler manner.

According to another aspect of the invention, there is provided a clutch including: a rotatable inner gear; a rotatable outer gear which has therein the inner gear; and a rack which is configured to mesh with the inner gear and to advance or recede between the inner gear and the outer gear in accordance with a normal rotation or a reverse rotation of the inner gear so as to engage with or disengage from the outer gear, wherein the outer gear receives a rotation torque from the inner gear via the engaged rack.

With such a configuration, the rotation torque is transmitted from the inner gear to the outer gear via the rack. Also, except for the time when a switching operation between the engagement state (the rack engages with the outer gear) and the disengagement state (the rack disengages from the outer gear) is carried out, the rack meshes with the inner gear so as to disable the relative movement therebetween regardless of whether it is a torque transmission state or a torque non-transmission state. Accordingly, it is possible to reduce a load applied to a motor and to silently operate the motor in the torque non-transmission state.

### BRIEF DESCRIPTION OF THE DRAWINGS

The invention will be described with reference to the accompanying drawings, wherein like numbers reference like elements.

FIG. 1 is an exploded perspective view showing a clutch according to the invention.

FIG. 2 is a front view (partially sectional view) showing the clutch according to the invention.

FIG. 3 is a front view (partially sectional view) showing the clutch according to the invention.

FIG. 4 is a schematic view showing a sheet feeding path of a sheet feeding device adopting the clutch according to the invention.

### DESCRIPTION OF EXEMPLARY EMBODIMENTS

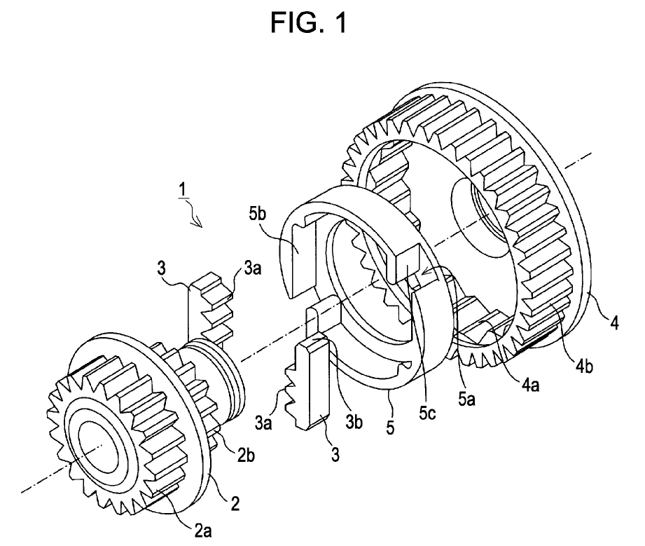

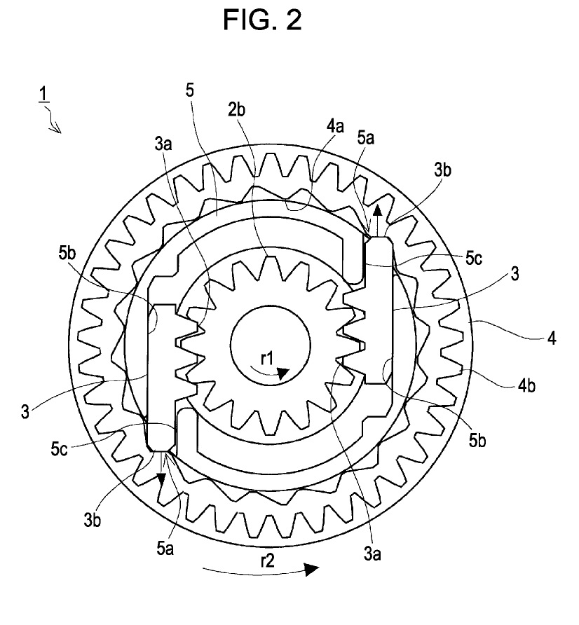

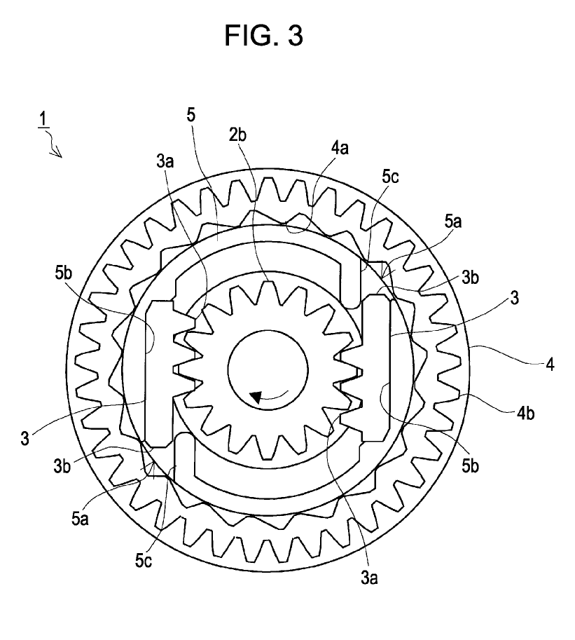

Hereinafter, an exemplary embodiment of the invention will be described with reference to FIGS. 1 to 4. FIG. 1 is an exploded perspective view showing a clutch 1 according to the embodiment of the invention. FIGS. 2 and 3 are front views (partially sectional views), where FIG. 2 is a view showing the state where a power is transmitted from an inner gear 2b to an outer gear 4 and FIG. 3 is a view showing the state where a power is not transmitted from the inner gear 2b to the outer gear 4.

As shown in FIGS. 1 to 3, the clutch 1 includes one multi gear 2 provided with an inner gear 2b; two racks 3; one outer gear 4; and one holder 5.

The multi gear 2 is a gear to which a rotation torque of a motor (not shown) is transmitted at a normal time, where an input gear 2a is integrally formed with the inner gear 2b. The input gear 2a is a gear meshing with a gear (not shown) to which the rotation torque of the motor is transmitted at a normal time. The inner gear 2b is a gear which is disposed inside the holder 5 so as to mesh with a gear portion 3a of the rack 3.

The holder 5 is formed in an annular shape so as to have therein the inner gear 2b and the racks 3. Also, the holder 5 includes guide surfaces 5b and 5c which are respectively used to slidably guide the racks 3. In this embodiment, two racks 3 are provided so as to be point symmetrical to each other with respect to a rotation center of the inner gear 2b and the holder 5. The racks 3 are configured to slide on the inside of the holder 5 while being guided by the guide surfaces 5b and 5c.

When the inner gear 2b rotates, the rotation torque is transmitted to the holder 5 via the racks 3, thereby rotating the holder 5 together with the inner gear 2b and the racks 3.

Here, the holder 5 is provided with openings 5a respectively formed at the arrangement positions of the racks 3, and a front end 3b of each rack 3 is configured to protrude to the outside of the holder 5 via each opening 5a. On the other hand, the outer gear 4 is formed in an annular shape so as to have therein the holder 5, and accommodates the inner gear 2b, the holder 5, and the racks 3 so as to be rotatable relative to the outer gear 4.

A gear portion 4b is formed on the outside of the outer gear 4. The gear portion 4b transmits the rotation torque of the motor to a target to be driven. In addition, plural protrusions 4a are formed on the inside of the outer gear 4 in a circumferential direction so as to have a predetermined interval therebetween. Each protrusion 4a is capable of coming into contact with the front end 3b of the rack 3. That is, the protrusion 4a forms a contact portion which comes into contact with the front end 3b of the rack 3.

Hereinafter, an operation of the clutch 1 having the above-described configuration will be described. FIG. 2 shows the case where the inner gear 2b rotates in a predetermined direction (in the example of FIG. 2, a counter-clockwise direction). When the inner gear 2b rotates in the counter-clockwise direction, the front ends 3b of the racks 3 protrude to the outside of the holder 5 so as to respectively come into contact with the protrusions 4a formed on the inside of the outer gear 4.

Accordingly, a torque transmission state is enabled. Here, the torque transmission state indicates the state where the rotation torque of the inner gear 2b is transmitted to the outer gear 4 via the racks 3. In addition, in the torque transmission state, the inner gear 2b, the racks 3, the holder 5, and the outer gear 4 rotate together.

Next, FIG. 3 shows the case where the inner gear 2b rotates in a direction opposite to the direction of FIG. 2 (in the example of FIG. 3, a clockwise direction). When the inner gear 2b rotates in the clockwise direction, the front ends 3b of the racks 3 do not protrude to the outside of the holder 5 so as to maintain the accommodation state where the racks 3 are accommodated in the outer gear 4.

That is, since the front ends 3b of the racks 3 do not come into contact with the protrusions 4a formed on the inside of the outer gear 4, a torque non-transmission state is enabled. Here, the torque non-transmission state indicates the state where the rotation torque of the inner gear 2b is not transmitted to the outer gear 4 via the racks 3. In addition, in the torque non-transmission state, the inner gear 2b, the racks 3, and the holder 5 rotate together upon receiving the rotation torque of the motor.

In the clutch 1 having the above-described configuration according to the invention, the switching operation between the torque transmission state (the rotation torque of the inner gear 2b is transmitted to the outer gear 4) and the torque non-transmission state (the rotation torque of the inner gear 2b is not transmitted to the outer gear 4) is carried out by the sliding operation of the racks 3 slidably provided in the holder 5. Also, except for the time when the switching operation between the torque transmission state and the torque non-transmission state is carried out, the racks 3 mesh with the inner gear 2b so as to disable the relative movement therebetween regardless of whether it is the torque transmission state or the torque non-transmission state. Accordingly, it is possible to reduce a load applied to the motor and to silently operate the motor in the torque non-transmission state.

In addition, in this embodiment, since plural (in this embodiment, two) racks 3 are arranged so as to be point symmetrical to each other with respect to the rotation center of the inner gear 2b, the torque transmission positions of the outer gear 4 are point symmetrical to each other with respect to the rotation center. Accordingly, it is possible to transmit the torque from the inner gear 2b to the outer gear 4 in a stabler manner.

Incidentally, the clutch 1 according to the invention has a function of enabling or disabling the torque transmission state in accordance with the rotation direction of the motor. However, in a recording apparatus represented as a facsimile or a printer, the clutch 1 can be used as follows.

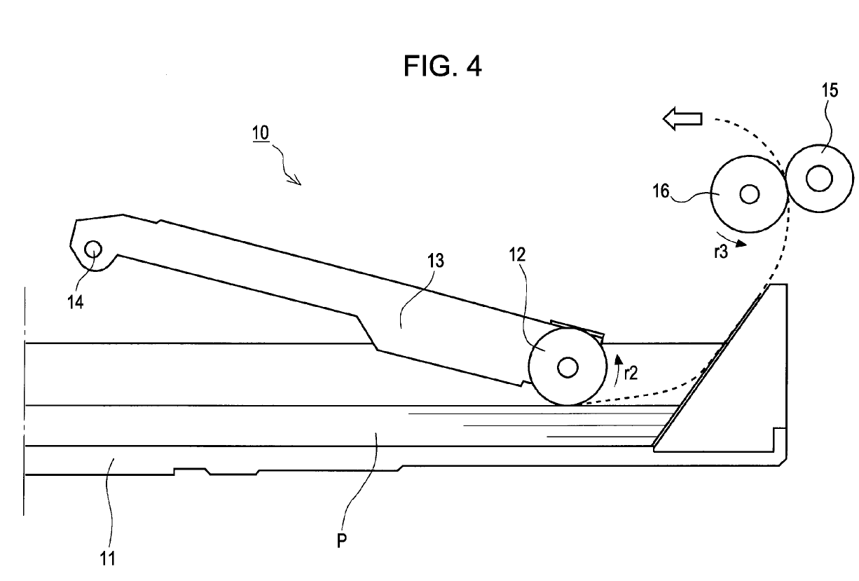

FIG. 4 is a schematic view showing a sheet feeding path of a sheet feeding device provided in a recording apparatus, where reference numeral 10 denotes the sheet feeding device and reference numeral 11 denotes a sheet cassette which is capable of accommodating a sheet P in a stacked state. In addition, reference numeral 12 denotes a pickup roller which is driven by a motor (not shown). The pickup roller 12, which is provided in a swing member 13 rotating about a swing shaft 14, is configured to contact with the uppermost sheet P so as to transport the uppermost sheet P to the downstream side.

In addition, reference numeral 16 denotes a transport driving roller which is installed on the downstream side of the pickup roller 12 and is driven by a motor (not shown). Reference numeral 15 denotes a transport driven roller which rotates in a following manner while coming into contact with the transport driving roller 16.

Here, in some cases, a sheet transport speed of the transport driving roller 15 is set to be faster than that of the pickup roller 12 so that the sheet is not loosened between the pickup roller 12 and the transport driving roller 15 during the sheet transporting operation. However, when the sheet transport speeds of both rollers are set, a slip occurs between the pickup roller 12 and the sheet P due to the tension occurring between the pickup roller 12 and the transport driving roller 15, thereby causing a problem in that a recording surface of the sheet P may be damaged.

However, such a slip occurring between the pickup roller 12 and the sheet P can be prevented when the clutch according to the invention is interposed in a gear mechanism which transmits a power from the motor to the pickup roller 12. Hereinafter, the slip preventing operation will be described in detail.

In FIG. 4, reference numeral r2 denotes a rotation speed of the pickup roller 12, and reference numeral r3 denotes a rotation speed of the transport driving roller 15. Here, in this embodiment, it is assumed that both rollers have the same outer diameter for the convenience of the description. Accordingly, since the sheet transport speed of the transport driving roller 15 is faster than that of the pickup roller 12, r3>r2.

In addition, in this embodiment, it is assumed that the deceleration ratio of the gear mechanism from the outer gear 4 to the pickup roller 12 is set to 1:1 for the convenience of description. Accordingly, when the pickup roller 12 rotates at the rotation speed r2, the outer gear 4 also rotates at the rotation speed r2.

Next, when the inner gear 2b shown in FIG. 2 is set to a gear to which the torque is transmitted from the motor as a driving source of the pickup roller 12 at a normal time and the outer gear 4 is set to a gear which is used to drive the pickup roller 12, as shown in FIG. 2, the outer gear 4 is rotationally driven at the rotation speed r2 by the inner gear 2b rotating at the rotation speed r1 until the front end of the sheet P arrives at the transport driving roller 15. At this time, the relationship between the rotation speed r1 of the inner gear 2b and the rotation speed r2 of the outer gear 4 is r1=r2.

Then, after the front end of the sheet P arrives at the transport driving roller 15, a tension occurs in the sheet P between the pickup roller 12 and the transport driving roller 15, and the speed of the pickup roller 12 tends to increase due to the tension of the sheet P. However, since the outer gear 4 is not restrained in a direction in which the rotation speed r2 increases as apparently shown in FIG. 1, the rotation speed r2 increases. That is, since the relationship of r1<r2 is satisfied, the pickup roller 12 can rotates without a slip occurring between the sheet P and the pickup roller 12.

As described above, even when the sheet transport speed of the transport driving roller 15 is set to be faster than that of the pickup roller 12, it is possible to prevent the slip occurring between the pickup roller 12 and the sheet P, and thus to prevent the recording surface of the sheet P from being damaged. Likewise, in the recording apparatus or the sheet feeding device provided with two rollers having different sheet transport speeds, the clutch according to the invention can be used to protect the recording surface by preventing the slip occurring between the sheet and the roller.

What is claimed is:

1. A clutch comprising:
an inner gear;
a rack which is configured to mesh with the inner gear;
a holder which is formed in an annular shape so as to have therein the inner gear and the rack and holds the rack so as to be slidable, the holder being configured to rotate together with the inner gear and the rack upon receiving a rotation torque of the inner gear via the rack; and
an outer gear which is formed in an annular shape so as to have therein the holder and is rotatable relative to the inner gear, the rack, and the holder,
wherein an opening is formed in the holder so as to allow the front end of the rack to protrude to the outside of the holder when the inner gear rotates in a predetermined direction,
wherein a contact portion is formed on the inside of the outer gear so as to come into contact with the front end of the rack protruding to the outside of the holder when the inner gear rotates in the predetermined direction, and
wherein the rack transmits the rotation torque of the inner gear to the outer gear via the contact portion when the inner gear rotates in the predetermined direction.

2. The clutch according to claim 1, wherein a plurality of the racks is provided, and the plurality of racks is disposed so as to be point symmetrical to each other with respect to a rotation center of the inner gear.

3. A clutch comprising:
a rotatable inner gear;
a rotatable outer gear which has therein the inner gear; and
a rack which is configured to mesh with the inner gear and to advance or recede between the inner gear and the outer gear in accordance with a normal rotation or a reverse rotation of the inner gear so as to engage with or disengage from the outer gear,
wherein the outer gear receives a rotation torque from the inner gear via the engaged rack.
